(19) United States
(12) Patent Application Publication
(10) Pub. No.: US 2009/0313574 A1
(43) Pub. Date: Dec. 17, 2009

(54) MOBILE DOCUMENT VIEWER

(75) Inventors: Sheng-Yao Shih, Taipei (TW); Tsui-Ying Fu, Taipei (TW); Chih-Chung Wang, Taipei (TW); Chih-Yung Chen, Taipei (TW); Shu-Fang Huang, Taipei (TW); Ming-Chieh Chang, Taipei (TW)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/139,506

(22) Filed: Jun. 16, 2008

(51) Int. Cl. G06F 3/048

(52) U.S. Cl. 715/781; 715/811

(57) ABSTRACT

Various technologies and techniques are disclosed for a mobile document viewer. Techniques for toggling between document formats are described. A request is received from a user to view a document on a mobile device. The document is retrieved in a first visual format and displayed. A request is received from the user to view the document in a second visual format. The document is retrieved in the second visual format and displayed. The document viewer contains three primary areas. A navigation bar has the most frequently used operations. A page content area follows the navigation bar and can display at least a portion of a document being viewed on the document viewer. A menu area follows the page content area and contains operations that can be performed on the document by a user. Techniques for optimizing the display of images within a document are also described.

### BACKGROUND

Mobile devices make it easier than ever before to access information while traveling. For example, most mobile phones and PDAs today provide the user with access to the Internet and sometimes company documents from within the small viewing window that the mobile phone or PDA has to offer.

As with most advances in technology, there are also some challenges. Mobile phones and PDAs have very small screens for displaying information to end users, so the displaying of information that was originally designed on a larger screen onto the smaller screen of a mobile device can be challenging. Furthermore, while many mobile devices may have a built-in Internet connection, the speed is generally still slower than the speed the user would get from a high speed Internet connection at their office. This means that it can take a lot longer to download typical documents over the slower Internet connection on the user's mobile device.

### SUMMARY

Various technologies and techniques are disclosed for a mobile document viewer. Techniques for toggling between document formats are described. A request is received from a user to view a document on a mobile device. The document is retrieved in a first visual format that is a different format than a format the document was originally created in. The document is then displayed. A request is received from the user to view the document in a second visual format. The document is retrieved in the second visual format that is a different format than a format the document was originally created in. The document is then displayed.

In one implementation, the document viewer contains three primary areas. A navigation bar has the most frequently used operations. A page content area follows the navigation bar and can display at least a portion of a document being viewed on the document viewer. A menu area follows the page content area and contains operations that can be performed on the document by a user.

In one implementation, a method for optimizing the display of images within a document on a mobile device is described. A request is received from a user to view a document on a mobile device in a fidelity view. A copy of the document is received in a fidelity format and with at least some of the images contained in the document being received as sub-images. A first page of the document is displayed in the fidelity view. The sub-images are displayed over a period of time as the sub-images are received.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a process flow diagram for one implementation illustrating the stages involved in toggling between a first visual format and a second visual format on a mobile device.

FIG. 2 is a process flow diagram for one implementation illustrating the stages involved in displaying a document in a readability format on a mobile device.

FIG. 3 is a simulated screen for one implementation that illustrates a document being displayed in a readability format on a mobile device.

FIG. 4 is a process flow diagram for one implementation illustrating the stages involved in displaying a document in a fidelity format on a mobile device.

FIG. 5 is a simulated screen for one implementation that illustrates a document being displayed in a fidelity format that is fit to the screen.

FIG. 6 is a simulated screen for one implementation that illustrates a document being displayed in a fidelity format in a zoomed-in mode to view more details.

FIG. 7 is a diagrammatic view for one implementation of illustrating the use of image splitting when rendering a document on the mobile device.

FIG. 8a is a diagrammatic view for one implementation of an original image that is contained in a document.

FIG. 8b is a diagrammatic view for one implementation of the original image contained in a document being split into sub-images for faster rendering on a mobile device.

FIG. 9 is a simulated screen for one implementation that illustrates a user interface layout for a mobile document viewer.

FIG. 10 is a simulated screen for one implementation that illustrates a navigation bar area and a page content area of a mobile document viewer.

FIG. 11 is a simulated screen for one implementation that illustrates a page content area and a menu area of a mobile document viewer.

FIG. 12 is a diagrammatic view of a computer system of one implementation.

### DETAILED DESCRIPTION

The technologies and techniques herein may be described in the general context as techniques for displaying documents on mobile devices, but the technologies and techniques also serve other purposes in addition to these. In one implementation, one or more of the techniques described herein can be implemented as features within an word processing program such as MICROSOFT® Office Word Mobile, from a presentation program such as MICROSOFT® Office PowerPoint Mobile, from a web browser program such as MICROSOFT® Internet Explorer Mobile, or from any other type of program or service that displays documents on a mobile device, and/or that communicates with a mobile device to return requested documents to the mobile device.

In one implementation, a mobile document viewer is described, which provides two different visual formats for users of a mobile device to view a document or presentation. In fidelity view, the page or slide is displayed in a fidelity format as images, so it preserves almost the same visual format as in the desktop application. The term “fidelity view” as used herein is meant to include a view in a mobile document viewer that displays documents in a fidelity format. The term “fidelity format” as used herein is meant to include documents that have been formatted as device independent formats such as images or PDF so that the document preserves almost the same visual format as in the original application. One example of a fidelity format is to convert a document from a MICROSOFT® Word document or a MICROSOFT® PowerPoint document into a device independent format such as a PDF or JPG so that the document is displayed on the mobile device in a visual layout similar to the desktop versions of those applications.

In readability view, the contents are displayed in a readability format where the content of each page or slide is adjusted in its layout to provide better readability. The term “readability view” as used herein is meant to include a view in a mobile document viewer that displays documents in a readability format. The term “readability format” as used herein is meant to include documents that have been formatted so that the content of each page is adjusted to provide better readability. One example of a readability format is to convert a document from a MICROSOFT® Word document or a MICROSOFT® PowerPoint document into an HTML format that adjusts the font size of the text to make it easier to read on the mobile device. In one implementation, the user can toggle between fidelity view and readability view as desired.

In another implementation, to provide better responsiveness of downloading large image files, the original image file is divided into smaller sub-images. In yet another implementation, the mobile document viewer has a user interface design which contains three primary sections: a navigation bar, followed by a page content area, followed by a menu area.

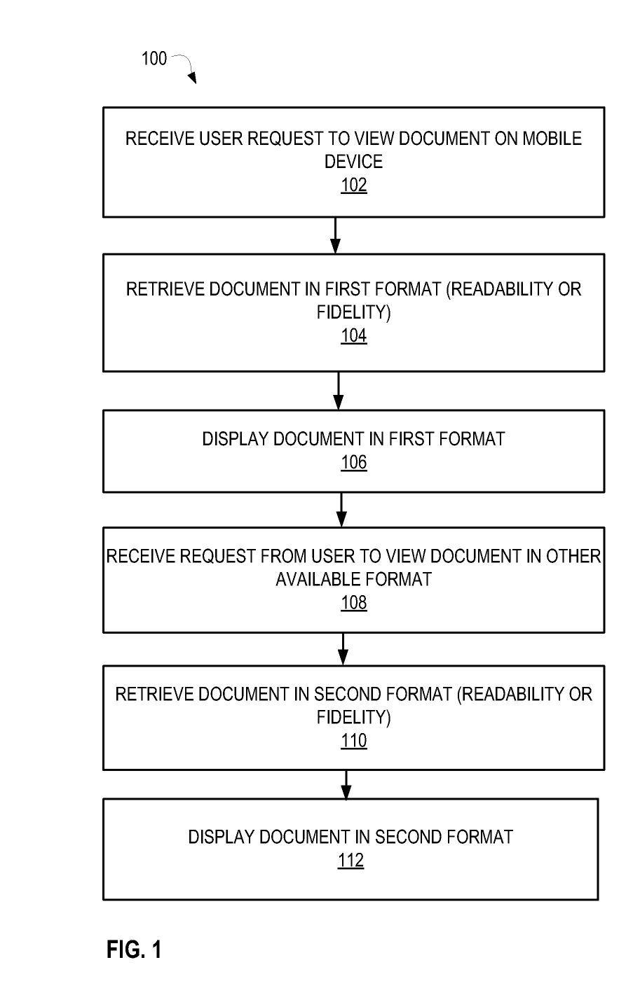

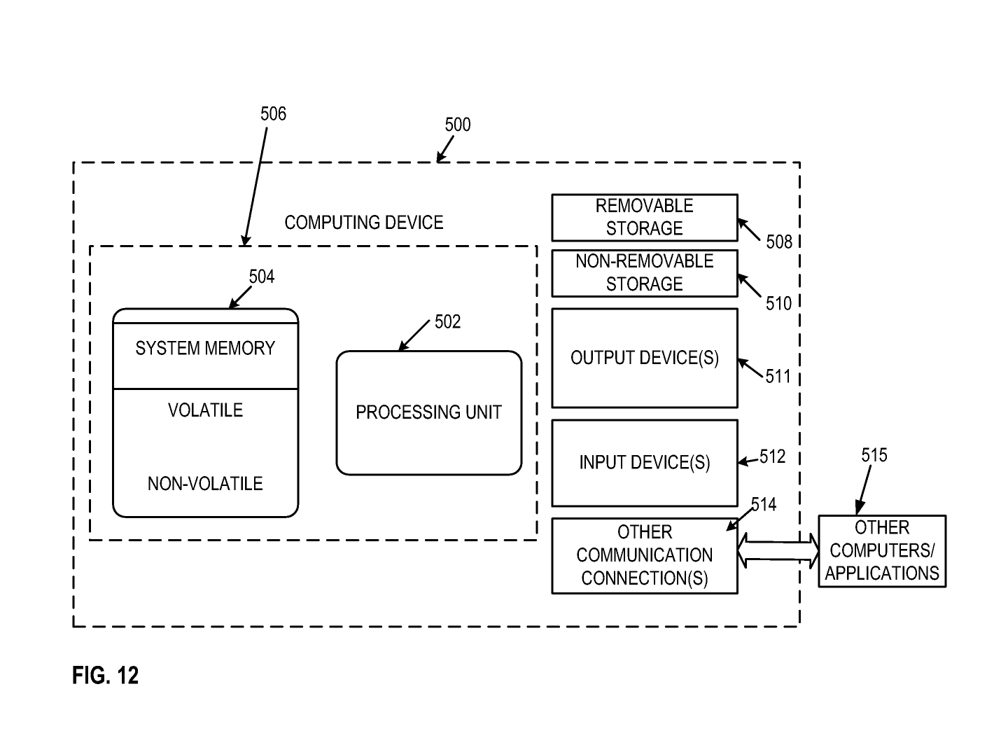

Turning now to FIGS. 1-11, the stages for implementing one or more implementations of mobile document viewer are described in further detail. In some implementations, the processes of FIG. 1-11 are at least partially implemented in the operating logic of computing device 500 (of FIG. 12).

FIG. 1 is a process flow diagram 100 for one implementation illustrating the stages involved in toggling between a first visual format and a second visual format on a mobile device. The term “visual format” as used herein is meant to include a visual representation of a document. A request is received from a user to view a document on a mobile device (stage 102). The document is retrieved in a first visual format, such as a readability format or a fidelity format (stage 104). In one implementation, the document is retrieved by communicating with the server that is storing the document. In another implementation, the document is retrieved locally from the mobile device. The document is displayed in the first visual format (stage 106). At a later point in time, a request is received from a user to view the document in another available visual format (stage 108). The document is retrieved in the second visual format, such as readability format or a fidelity format (stage 110). In one implementation, the communication is established with the server to retrieve the document in the second format. In another implementation, the document is retrieved in the second visual format locally from a mobile device. The document is displayed in the second format (stage 112). The user can toggle back and forth between the first visual format and the second visual format as desired. For example, when the user wishes to read the text of the document, readability view can be used. When the user wishes to see how the document looked in its original format, the fidelity view can be used. These views are described in further detail in the figures that follow.

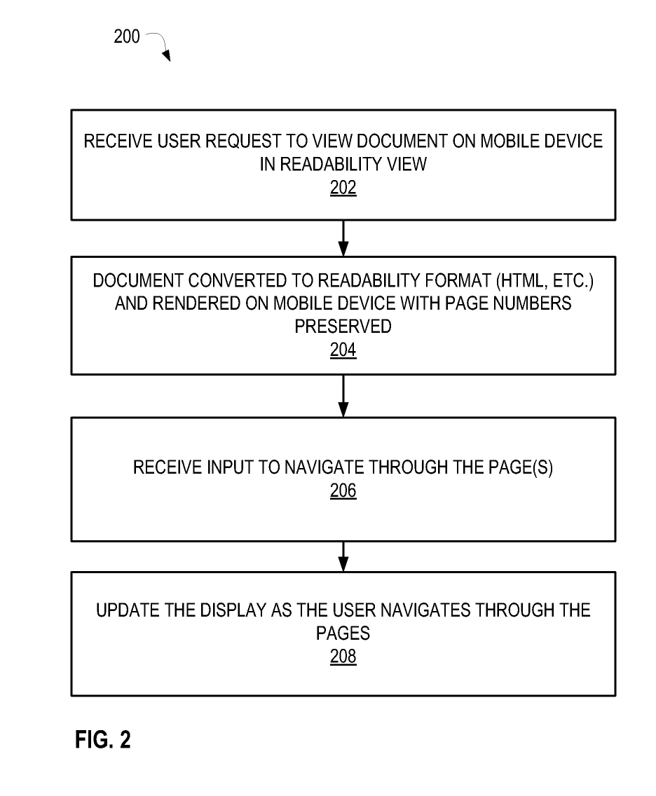

FIG. 2 is a process flow diagram 200 for one implementation illustrating the stages involved in displaying a document in a readability format on a mobile device. A request is received from a user to view a document on a mobile device in a readability view (stage 202). A document is converted to a readability format and is rendered on the mobile device with page numbers preserved (stage 204). In one implementation, the readability format that is used is HTML. In such a scenario, the original source document is converted into an HTML format so that adjustments can be made to font size, etc., to make the text itself easier to read. As another example, long sentences in readability view can be wrapped differently as compared to the desktop application so they fit better on the smaller screen. Images or tables can be re-sized to fit on the smaller screen, or they can be hidden from view until the user wishes to view them.

In one implementation, even when the document is converted to readability format (such as HTML), the pages are converted with the original page numbers being preserved. In other words, if a MICROSOFT® Word document, for example, was being converted to HTML for readability view, then page one of the original MICROSOFT® Word document would be rendered as page one in the HTML document being displayed on the mobile device in readability view. User input is received to navigate through the pages (stage 206). The display is updated as the user navigates through the pages (stage 208).

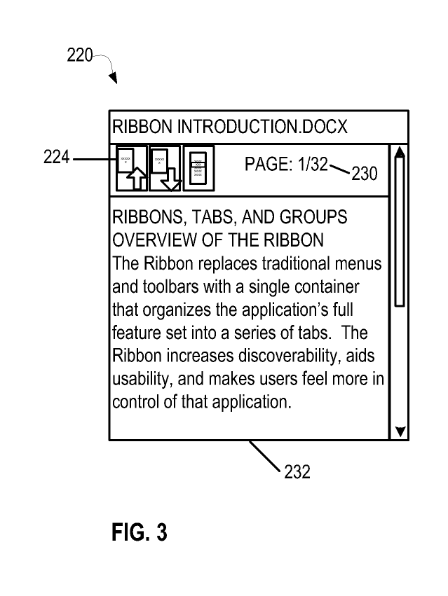

In one implementation, a communication is established with a server as each page is accessed to retrieve the document converted into the readability format. In another implementation, the document is downloaded to the mobile device in the readability format and then accessed locally from the mobile device as the user navigates from page to page. In yet another implementation, the document is downloaded to the mobile device in its original format, and then converted to the readability format directly on the mobile device. An example of a readability view that displays a document in a readability format will now be shown in FIG. 3.

FIG. 3 is a simulated screen 220 for one implementation that illustrates a document being displayed in a readability format on a mobile device. In the example shown, the document is a MICROSOFT® Word document that has been converted to HTML format for readability. A navigation bar 224 is shown at the top, along with page numbers 230. The page content area 232 contains the content of the document in the HTML format. The font size has been adjusted to make the text easier to read.

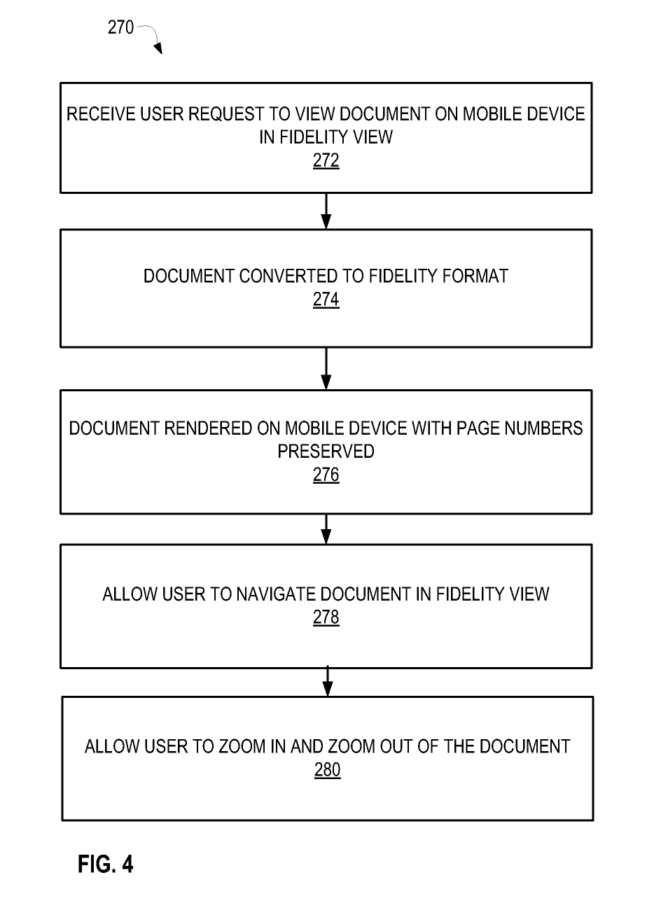

FIG. 4 is a process flow diagram 270 for one implementation illustrating the stages involved in displaying a document in a fidelity format on a mobile device. A request is received from a user to view a document on a mobile device in a fidelity view (stage 272). The document is converted to a fidelity format that is a device independent image format (stage 274), if it has not already been converted into the fidelity format. Examples of a device independent format can include JPG, TIF, PDF, etc. The document is rendered on the mobile device in the fidelity format with page numbers preserved (stage 276). The user is able to navigate the document in fidelity view (stage 278). The user can zoom in and zoom out of the document to see portions of the document more clearly (stage

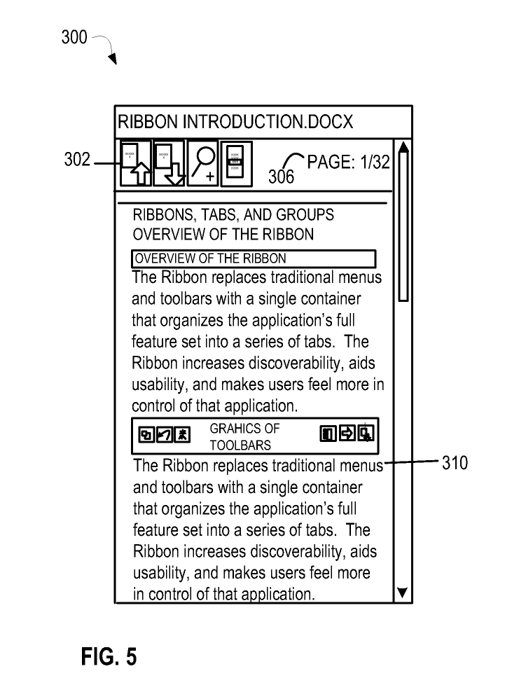

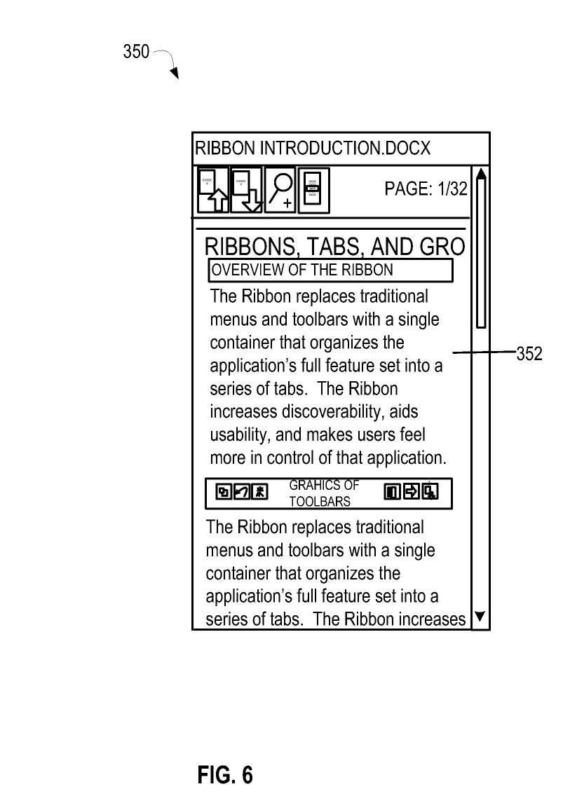

In one implementation, the document is retrieved from a server in the fidelity format all at one time, and then different pages are accessed as the user selects an option to view a certain page. In another implementation, the document is retrieved from a server in the fidelity format one page at a time as the user accesses a given page on the mobile device. In yet another implementation, the document is retrieved in its original format and then converted directly on the mobile device into the fidelity format. Some examples of a fidelity view that displays documents in a fidelity format will now be shown in FIGS. 5 and 6.

FIG. 5 is a simulated screen 300 for one implementation that illustrates a document being displayed in a fidelity format that is fit to the screen. The document being shown in FIG. 5 is the same document that was shown in FIG. 3 in readability view in an HTML format. In this example, the document is now being shown in the fidelity view in an image format. The navigation bar 302 is contained at the top of the screen, along with the page number 306. The page content area 310 displays the contents of the document in an image format, so that it is rendered on the mobile device in a format that closely resembles the way it looks in the original desktop application.

FIG. 6 is a simulated screen 350 for one implementation that illustrates a document being displayed in a fidelity format in a zoomed-in mode to view more details. In this example, the page content area 352 has been zoomed-in so that the details of the image (i.e. the document contents) can be seen more clearly.

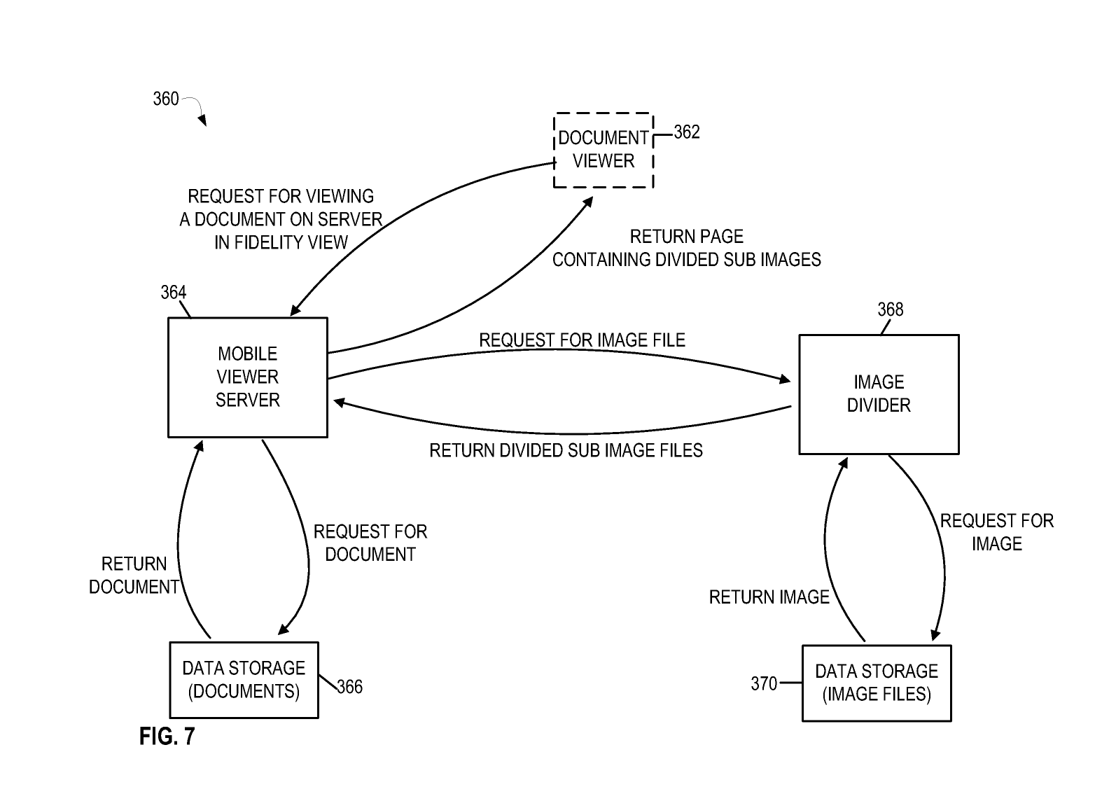

FIG. 7 is a diagrammatic view 360 for one implementation of illustrating the use of image splitting when rendering the document on a mobile device. When a mobile document viewer 362 receives a user or other request for a document to be viewed in a fidelity view, then a request is sent to a server to retrieve the document in a fidelity view. A mobile viewer server 364 receives the request from the mobile document viewer 362 and retrieves the document from data storage 366. A request is sent to an image divider 368 split the image of the document into multiple images. The image divider 368 retrieves the image(s) from data storage 370 and then splits the image(s) into sub-images and returns the sub-images to the mobile viewer server 364. The mobile viewer server 364 then returns the requested document back to the mobile document viewer 362 on the mobile device with at least some of the images in the document being received as sub-images. The first page of the document is displayed in the fidelity view, and any of the sub-images it contains are displayed over the period of time as they are received. In other words, the page of the document being requested gets split into sub-images on the server, and then each sub-image is displayed on the mobile device as it is downloaded until the complete page has been rendered. This gives the user the feeling that the images are loading faster than if the entire image was just displayed all at once after the entire image was downloaded (even if it ends up taking the same amount of time to show the complete image).

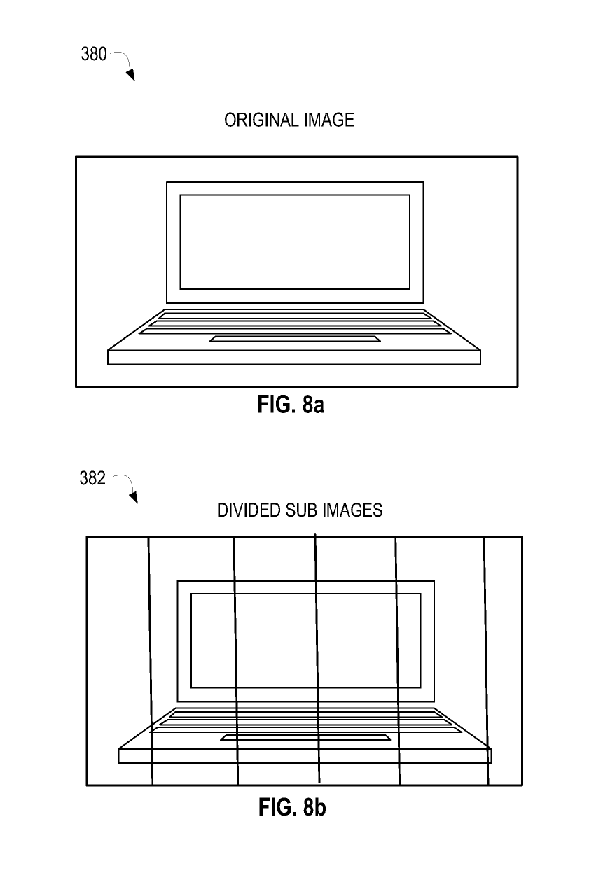

FIG. 8a is a diagrammatic view 380 for one implementation of an original image that is contained in a document. This image has not yet been converted into sub-images as described in FIG. 7. FIG. 8b is a diagrammatic view 382 of the original image from FIG. 8a being split into sub-images for faster rendering on a mobile device.

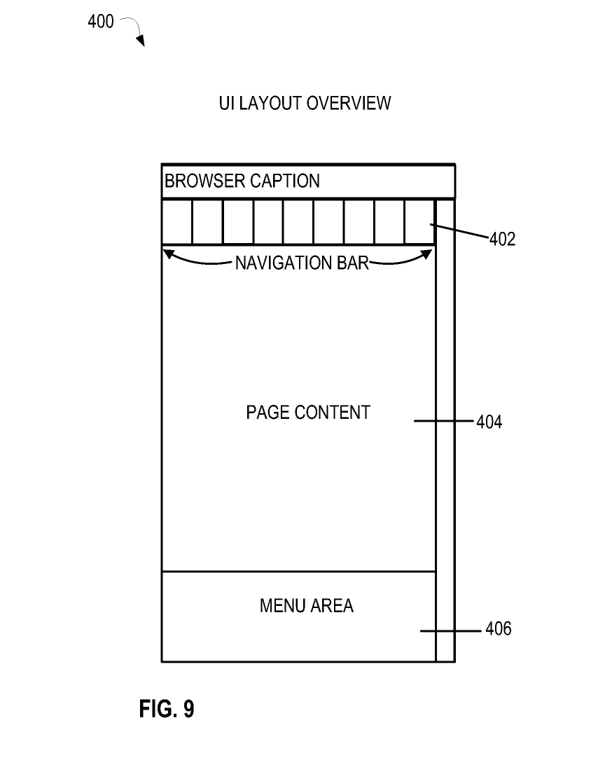

Turning now to FIGS. 9-11, an exemplary user interface design for a mobile document viewer 400 is described. FIG. 9 is a simulated screen for one implementation that illustrates a user interface layout for a mobile document viewer. Mobile document viewer 400 contains a navigation bar 402, followed by a page content area 404, and then followed by a menu area 406. The order of these three regions can be horizontal or vertical. In other words, in a vertical order of these regions, the navigation bar 402 would be displayed in a top section, followed by the page content area 404 in a middle section, followed by the menu area 406 in a bottom section. In a horizontal order of these regions, the navigation bar 402 would be displayed in a left section, followed by the page content area 406 in a middle section, followed by the menu area 406 in a right section.

Navigation bar 402 has a plurality of most frequently used operations. In other words, the operations that are used most frequently by users are included for easy access. A few non-limiting examples of the most frequently used operations can include go to previous page, go to next page, and jump to the bottom to the menu area. These are just a few non-limiting examples, and other frequently used operations could be displayed in navigation bar 402 instead of or in addition to these.

Mobile document viewer 400 also has a page content area 404 that follows the navigation bar. The page content area 404 is operable to display at least a portion of a document being viewed on the document viewer. In the event that there is more content in the document than can fit on the viewing area at once, then scroll bars can be included to allow the user to scroll to see the rest of the content on that page. These scrollbars can be vertical, horizontal, and/or both orientations.

Mobile document viewer 400 also contains a menu area 406 that follows the page content area. The menu area 406 contains a plurality of operations that can be performed on the document by a user. These operations can include some of the same operations as those shown in the navigation bar 402, but in such situations, also contains more operations than those contained in the navigation bar 402.

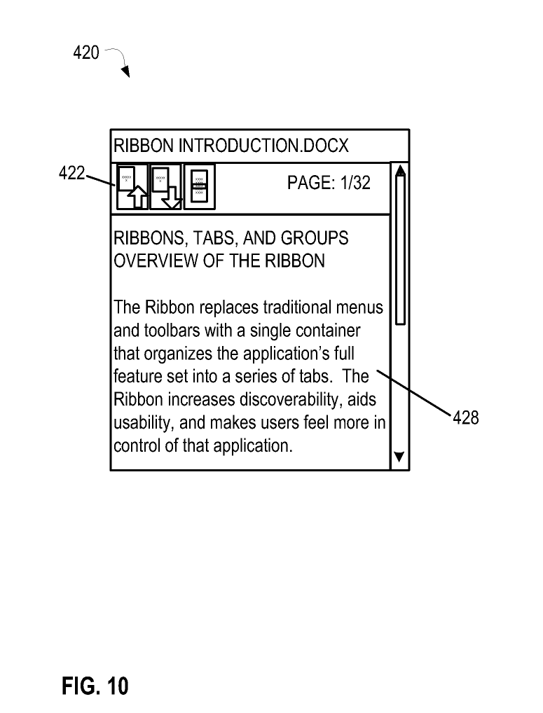

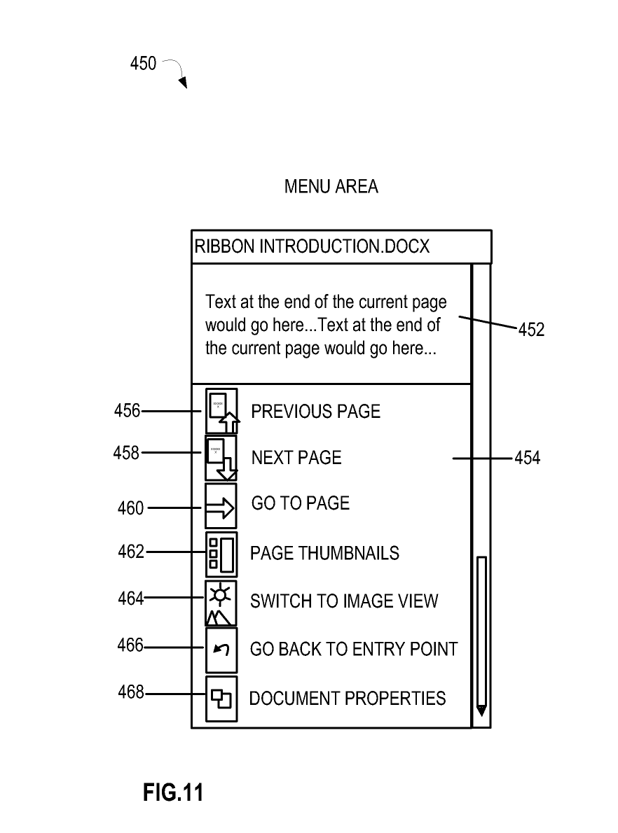

Depending on the size of a document being displayed in mobile document viewer 400, only some or all of these three areas (402, 404, and 406) may be visible at a given time. For example, when the content of the document does not all fit within the page content area 404, then the user may have to scroll in order to view menu area 406. Examples of this are shown in FIGS. 10 and 11.

FIG. 10 is a simulated screen 420 for one implementation that illustrates a navigation bar area 422 and a page content area 428 of a mobile document viewer. Since the page being viewed does not all fit within the page content area 428, a scroll bar is displayed to allow the user to scroll down and see the rest of the content on that page.

FIG. 11 is a simulated screen 450 for one implementation that illustrates a page content area 452 and a menu area 454 of a mobile document viewer. Once the user reaches the bottom of the page content area 452 for the page being displayed, then the additional operations that can be performed are displayed. In this example, the additional operations that are available include: go to previous page 456, go to next page 458, go to a certain page 460, view page thumbnails 462, switch to image (fidelity) view 464, go back to entry point 466, and view document properties 468. These are just examples of some of the types of operations that may be included, and others could also be used in other implementations.

As shown in FIG. 12, an exemplary computer system to use for implementing one or more parts of the system includes a computing device, such as computing device 500. In its most basic configuration, computing device 500 typically includes at least one processing unit 502 and memory 504. Depending on the exact configuration and type of computing device, memory 504 may be volatile (such as RAM), non-volatile (such as ROM, flash memory, etc.) or some combination of the two. This most basic configuration is illustrated in FIG. 12 by dashed line 506.

Additionally, device 500 may also have additional features/functionality. For example, device 500 may also include additional storage (removable and/or non-removable) including, but not limited to, magnetic or optical disks or tape. Such additional storage is illustrated in FIG. 12 by removable storage 508 and non-removable storage 510. Computer storage media includes volatile and nonvolatile, removable and non-removable media implemented in any method or technology for storage of information such as computer readable instructions, data structures, program modules or other data. Memory 504, removable storage 508 and non-removable storage 510 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by device 500. Any such computer storage media may be part of device 500.

Computing device 500 includes one or more communication connections 514 that allow computing device 500 to communicate with other computers/applications 515. Device 500 may also have input device(s) 512 such as keyboard, mouse, pen, voice input device, touch input device, etc. Output device(s) 511 such as a display, speakers, printer, etc. may also be included. These devices are well known in the art and need not be discussed at length here.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the examples discussed herein could be organized differently on one or more computers to include fewer or additional options or features than as portrayed in the examples.

What is claimed is:

1. A method for toggling between document formats on a mobile device comprising the steps of:
receiving a request from a user to view a document on a mobile device;
retrieving the document in a first visual format, the first visual format being a different format than a format the document was originally created in;
displaying the document in the first visual format;
receiving a request from the user to view the document in a second visual format, the second visual format being another different format than the format the document was originally created in;
retrieving the document in the second visual format; and
displaying the document in the second visual format.

2. The method of claim 1, wherein the retrieving of the document in the first visual format is performed by communicating with a server to have the server return the document in the first visual format.

3. The method of claim 1, wherein the retrieving of the document in the second visual format is performed by communicating with a server to have the server return the document in the second visual format.

4. The method of claim 1, wherein the first format is a fidelity format and the second format is a readability format.

5. The method of claim 1, wherein the first format is a readability format and the second format is a fidelity format.

6. The method of claim 1, wherein the first format is a readability format where the original document has been converted into an HTML format.

7. The method of claim 6, wherein original page numbers of the document are preserved when rendering the document in the HTML format.

8. The method of claim 6, wherein text contained in the document is adjusted to a different font size in the HTML format to make the text easier to read on the mobile device.

9. A document viewer comprising:
a navigation bar, the navigation bar containing a plurality of most frequently used operations;
a page content area that follows the navigation bar, the page content area being operable to display at least a portion of a document being viewed on the document viewer; and
a menu area that follows the page content area, the menu area containing a plurality of operations that can be performed on the document by a user.

10. The document viewer of claim 9, wherein the navigation bar, the page content area, and the menu area are arranged in a vertical order.

11. The document viewer of claim 10, further comprising:
vertical scrollbars to allow the user to scroll through the page content area to reach the menu area.

12. The document viewer of claim 9, wherein the navigation bar, the page content area, and the menu area are arranged in a horizontal order.

13. The document viewer of claim 12, further comprising:
horizontal scrollbars to allow the user to scroll through the page content area to reach the menu area.

14. The document viewer of claim 9, wherein additional operations are contained in the menu area that are not available in the navigation bar.

15. The document viewer of claim 9, wherein at least one of the plurality of operations contained in the menu area is one of the most frequently used operations contained in the navigation bar.

16. The document viewer of claim 9, wherein the document viewer is operable to communicate with a server and retrieve the document one page at a time.

17. A method for optimizing a display of images within a document on a mobile device comprising the steps of:
receiving a request from a user to view a document on a mobile device in a fidelity view;
receiving a copy of the document in a fidelity format and with at least some of the images contained in the document being received as sub-images; and
displaying a first page of the document in the fidelity view.

18. The method of claim 17, wherein the sub-images are displayed over a period of time as the sub-images are received.

19. The method of claim 17, wherein the copy of the document is received from a server.

20. The method of claim 19, wherein the copy of the document is received one page at a time as the user requests to view another page of the document in the fidelity view.
